(19) United States
(12) Patent Application Publication
(10) Pub. No.: US 2007/0228311 A1
(43) Pub. Date: Oct. 4, 2007

(54) Pressure balanced valve

(76) Inventor: Gerrit V. Beneker, St. Clair Shores, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/390,677

(22) Filed: Mar. 28, 2006

(51) Int. Cl. F16K 31/02

(52) U.S. Cl. 251/129.07

(57) ABSTRACT

A pressure balanced solenoid control valve comprises a member including a bore having a first end and a second end, an armature extending at least partially into the bore through the first end; and a pole piece extending at least partially into the bore through the second end. An inlet pressure is provided between the armature and pole piece to bias the armature away from the pole piece. A method for operating a solenoid control valve is also disclosed.

### FIELD OF THE DISCLOSURE

The present disclosure relates generally to control valves and to a pressure balanced valve.

### BACKGROUND

Conventional solenoid control valves are not generally optimized with respect to performance, size, and cost. For example, a conventional, normally-closed engine oil solenoid control valve 100 is generally shown in FIG. 7. Such a valve typically includes an oil pressure supply port, a control port, and an exhaust port, which are designated SP, CP, and EP, respectively. The supply port (SP) provides a source of hydraulic fluid pressure, such as engine oil under pressure, to an inner armature bore 101. A ball valve 103 communicates oil pressure from the armature bore to one or more first side passages 102 that define a control port (CP). A check valve 105 communicates oil flow from the armature bore to one or more second side passages 104 that define an exhaust port (EP).

In operation, the control port (CP) controls the activation/deactivation of the valve lifter system as the check valve together with a bleed orifice prevents oil pressure of the valve lifter activation/deactivation system from falling below a selected minimum oil pressure value when the valve lifter activation/deactivation system is reactivated. To ensure that the control valve 100 remains shut-off against the associated inlet pressure, a large, heavy spring 106 is commonly required to bias a large, heavy armature rod 108 positioned in a can 110.

The requirement of the spring 106 in the design of the control valve 100 is often necessary to address the uncertainty associated with a wide range of potential hydraulic fluid pressures. Such pressures, which can result from varying operating temperatures and engine rpm, can range, for example, from 20 psi to more than 100 psi. Thus, the bias provided by the design of the spring 106 may actually overcompensate for low fluid pressure conditions, and, conversely, may be inadequately adapted for high fluid pressure conditions. More power is commonly needed to overcome a large, heavy spring. That need can, in effect, increase the required magnetic flux needed to operate the solenoid control valve 100, which can require more material (e.g. copper and iron). Even further, because the size of the armature 108 is relatively large, a diameter D2 and length L2 of the can 110 for the solenoid control valve 100 may be increased as well, which can limit the number of applications that the control valve 100 may be used for or incorporated into. Yet even further, although conventional control valves 100 that include ball valves 103 and/or check valves 105 for operating the control and exhaust ports may be less expensive, the associated on/off performance of such control valves 100 tend to undesirably vary in response to different fluid pressures seen at the supply port.

### SUMMARY

A pressure balanced solenoid control valve comprises a member including a bore having a first end and a second end, an armature extending at least partially into the bore through the first end; and a pole piece extending at least partially into the bore through the second end. An inlet pressure is provided between the armature and pole piece to bias the armature away from the pole piece. A method for operating a solenoid control valve is also disclosed.

### BRIEF DESCRIPTION OF THE DRAWINGS

Embodiments of the disclosure will now be described, by way of example, with reference to the accompanying exemplary drawings, wherein:

FIG. 1 is an exploded perspective view of a pressure balanced solenoid control valve according to an embodiment of the present invention;

FIG. 2 is a side view of a pressure balanced solenoid control valve according to an embodiment of the present invention;

FIG. 3 is a cross-sectional view of a pressure balanced solenoid control valve taken along line 3-3 of FIG. 2;

FIG. 4 illustrates an example of an “on response” chart for a pressure balanced solenoid control valve according to an embodiment of the present invention;

FIG. 5 illustrates an example of an “off response” chart for a pressure balanced solenoid control valve according to an embodiment of the present invention;

FIG. 6 illustrates an example of an on/off response correlation chart for a pressure balanced solenoid control valve according to an embodiment of the present invention; and

FIG. 7 illustrates a side cross-sectional view of a conventional solenoid control valve.

### DETAILED DESCRIPTION

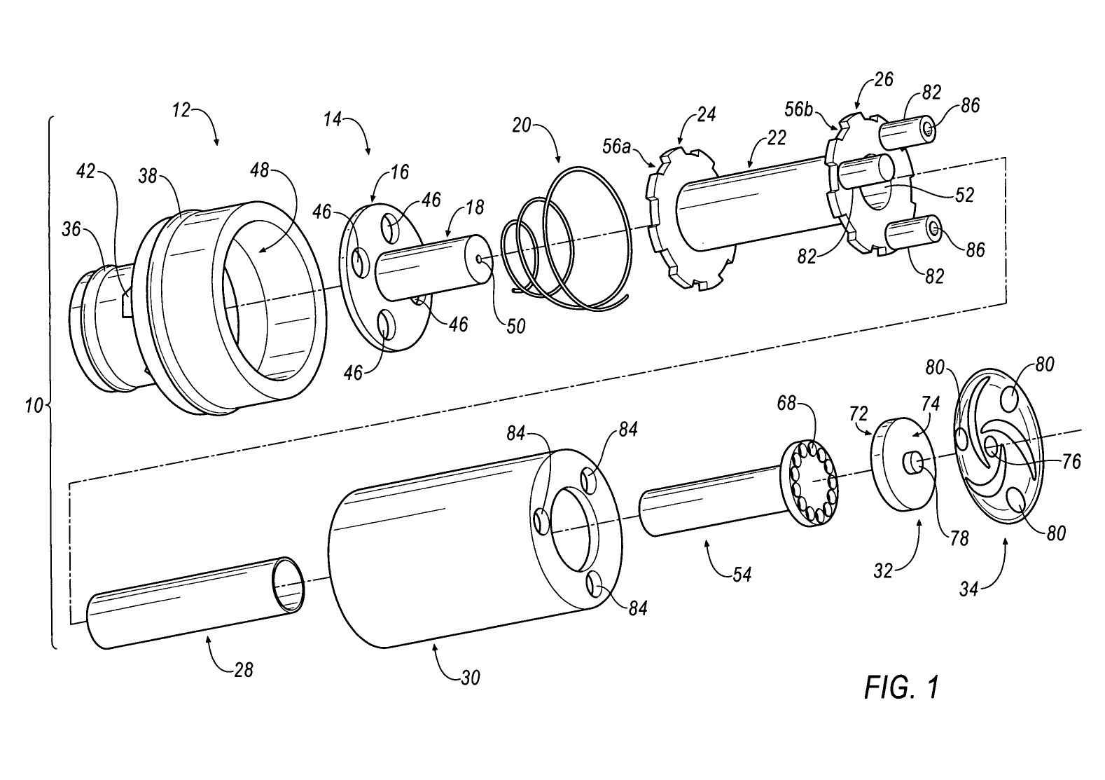

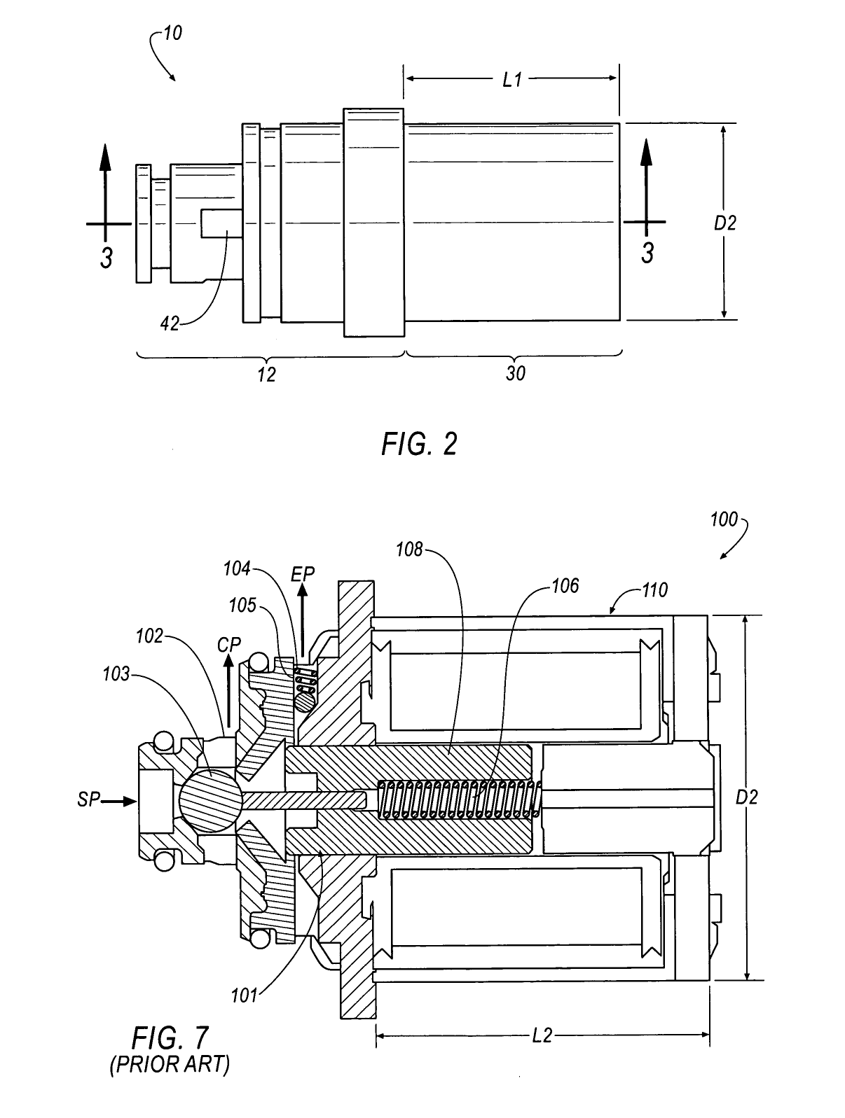

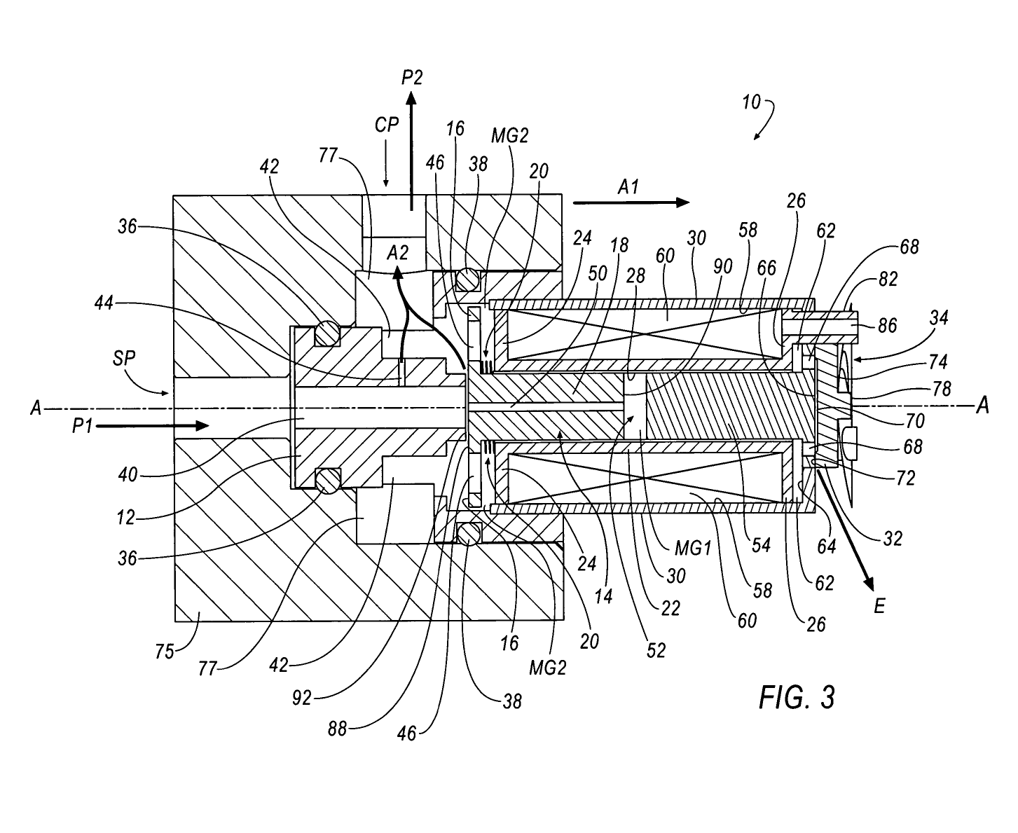

A pressure balanced solenoid control valve 10, according to an embodiment of the present invention, is generally illustrated in FIGS. 1-3. The illustrated control valve 10 may be used, for example, to activate/deactivate a feature, such as a valve lifter system (not shown). As depicted in FIG. 3, the control valve 10 may be aligned with a fluid pressure supply port SP and a control port CP of an engine block 75 to operate, for example, a valve lifter system. The supply port SP provides a source of hydraulic fluid inlet pressure P1, such as engine oil under pressure, to the control valve 10, and, the control port CP allows fluid communication for the activation/deactivation of a feature, such as for a valve lifter system, with an outlet pressure P2.

As seen in FIG. 1, the pressure balanced solenoid control valve 10 includes a nose portion 12; an armature 14 (e.g., formed with steel) that includes a disk portion 16 and neck portion 18; and a pole piece 54 opposite the armature, which may, if desired, be integral with the can 30. The pressure balanced solenoid control valve 10 also includes a conical coil armature spring 20, and a bobbin 22 with first and second end plates 24,26. The pressure balanced solenoid control valve 10 may also include a can 30, a fluid exhaust lid 32, and/or a leaf spring 34 nested between the fluid exhaust lid 32 and a leaf spring retainer (not shown), and an optional bobbin sleeve 28.

Referring to FIG. 3, the nose portion 12 may include first and second sealing elements 36, 38 that are axially aligned with a central axis A (taken along A-A) of the supply port SP. The nose portion 12 may also include an axial fluid supply bore 40 in communication with one or more radial fluid passages 42 and radial bleed orifices 44, to permit fluid communication from nose portion 12 to, for example, an engine block bore 77 that may be in fluid communication with one or more control ports, CP.

The armature disk 16 may include one or more axial fluid passages 46 and may be received within a receiving bore 48 (see, e.g., FIG. 1) formed in the nose portion 12. The armature neck 18 may include an axial pressure balancing orifice 50 that can be axially aligned with central axis A for fluid communication to a first axial magnetic air gap MG1 (see, e.g., FIG. 3). The first axial magnetic air gap MG1 may be located between the armature neck 18 and a pole piece 54 in a bore 52 formed in the bobbin 22 that is axially aligned with the central axis A. When the bobbin 22 and can 30 are positioned in axial alignment with the armature 14 about central axis A, a second axial magnetic air gap MG2 can be formed between the armature disk 16 and can 30. This supplies an additional pulling force on the armature, which by contrast is commonly wasted by a standard radial air gap (see, e.g., element 101 in FIG. 7—not pulling in the direction of motion). If incorporated, the optional bobbin sleeve 28 is received about an outer surface of the armature neck 18 and pole piece 54 within the bobbin bore 52.

In a de-energized state, to permit fluid exhaust during operation of the pressure balanced solenoid control valve 10, while maintaining a residual outlet pressure P2, the fluid exhaust lid 32 and leaf spring 34 may function as an exhaust regulator. For instance, fluid exhaust may initiate at the bleed orifice 44, and through the first end plate 24 of the bobbin 22 about axially-formed bleed notches 56a (see, e.g., FIG. 1) that permit fluid flow (in the direction generally depicted by arrow A1), between an inner can wall 58 and coil 60 to a fluid passage 62 formed between the second end plate 26 and an end wall 64 of the can 30 generally at or proximate pole piece end 66. The fluid flowing between the inner can wall 58 and coil 60 in this manner can help cool the coil 60 during operation of the pressure balance solenoid control valve 10. Fluid flow to pole piece end 66 may be enabled, for example, using axially-formed bleed notches 56b (see, e.g., FIG. 1) that are similarly formed in second end plate 26.

The pole piece end 66 may be configured to include a plurality of axial bleed passages 68 (see, e.g., FIG. 1) that are at least partially enclosed by a shallow cavity 70 formed on a first surface 72 of the fluid exhaust lid 32 opposite a second surface 74 of the fluid exhaust lid 32. With such an embodiment, fluid can be permitted to flow through the pole piece end 66, out through the plurality of axial bleed passages 68. Accordingly, under the bias of the leaf spring 34, a regulation of fluid exhaust can be permitted to occur in the general direction of the arrow E, between the fluid exhaust lid 32 and pole piece 54/can 30 into a fluid bath (not shown). According to an embodiment, the axial bleed passages 68 are included in the design of the pressure balanced solenoid control valve 10 when the pole piece 54 is integral with the can 30.

In an embodiment, leaf spring 34 may include an axial passage 76 (see, e.g., FIG. 1) aligned with the central axis A, such that the leaf spring 34 may be receivably-supported about a male portion 78 extending from the second surface 74 of the fluid exhaust lid 32. The leaf spring 34 may also include locator passages, such as the three locator passages 80 (see, e.g., FIG. 1), that receive corresponding posts 82 that may extend from second end plate 26. To accommodate passage of the posts 82, can 30 may include post bores 84 (see, e.g., FIG. 1). Further, if desired, posts 82 may include a wire-receiving bore 86 to permit passage of wires (not shown) to provide power to coil 60.

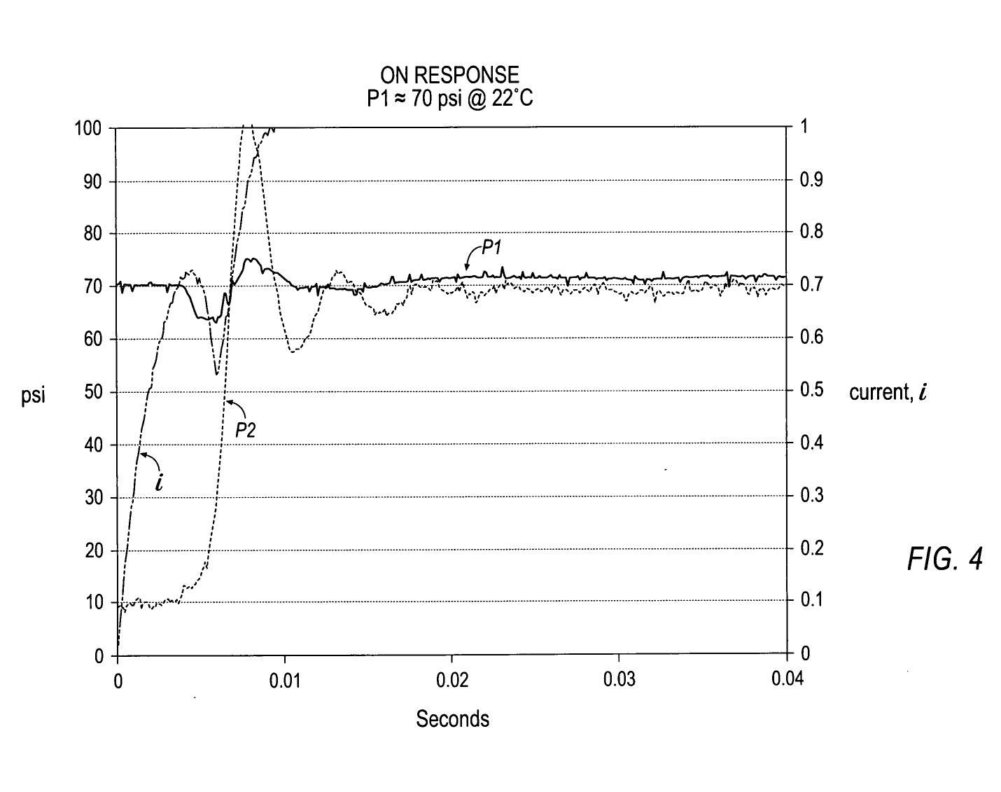

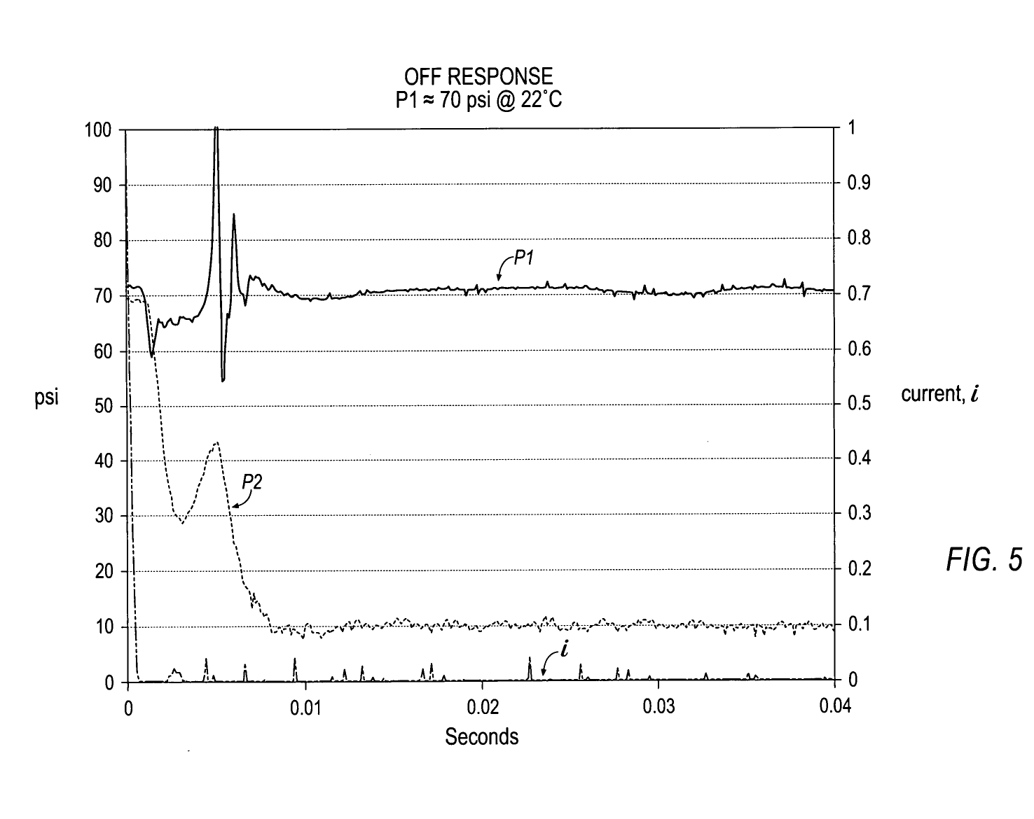

With reference to FIGS. 4-6, fluid pressure entering the supply port SP is generally defined as an inlet pressure P1, and fluid pressure exiting the control port CP for activating/deactivating a feature, such as, for example, a valve lifter system, is generally defined as an outlet pressure P2. The charts illustrated in FIGS. 4 and 5 generally represent an “on response” and an “off response,” respectively, of the pressure balanced valve 10 for a particular embodiment. Each chart is referenced by a fluid inlet pressure P1 of 70 psi at 22° C. with a coil that is energized by a 9-volt supply. The units of the horizontal axis represent time, on the order of seconds. The units of the left vertical axis of the chart represent pressure in psi (pounds per square inch), and the units of the right vertical axis of the chart represent a unit of electricity in current/amperes (“i”).

Prior to energizing the coil 60, i.e., prior to plotting the ‘on response’ such as shown in FIG. 4, inlet pressure P1 occurs in the axial supply bore 40 of the nose portion 12 and at the first axial magnetic air gap MG1 by way of the axial pressure balancing orifice 50. As such, the inlet pressure P1 is present on each side of the armature 14 (i.e., at a first end 88 of the armature 14 proximate the disk 16 and at a second end 90 of the armature 14 proximate the neck 18). Therefore, because the armature 14 encounters inlet pressure P1 at its second end 90, the armature 14 is biased against an inner wall 92 of the nose portion 12 when the pressure balanced solenoid control valve 10 is in an “off” state. As such, fluid inlet pressure P1 present in the magnetic air gap MG1 is utilized, at least in part, to bias the pressure balanced solenoid control valve 10, when in an “off” state. Such biasing can be accomplished without employing a conventional large, heavy spring and armature, which could increase size and cost while also reducing performance of the solenoid control valve 10.

When the coil 60 is energized, an “on response” (see, e.g., FIG. 4) of the pressure balanced solenoid control valve 10 can occur. With such a response, armature 14 may be drawn or pulled toward can 30 in the direction generally designated by arrow A1, thereby reducing the length of the magnetic air gaps, MG1, MG2, and forcing the inlet pressure P1 of the fluid in the direction generally designated by arrow A2 through the one or more radial fluid passages 42 and radial bleed orifices 44, and out to the control port CP.

Accordingly, with reference to FIG. 4, when the pressure balanced solenoid control valve 10 is activated, a pressure value that is equal to the inlet pressure P1 is provided to the control port CP for the outlet pressure P2 for activating a feature, such as, for example, a valve lifter system. Additionally, the fluid exhaust regulation, as provided by the fluid exhaust lid 32 and leaf spring 34, is essentially shut off as a result of the exhaust lid 32 being pulled with a force in the direction opposite the direction generally designated by arrow A1, such that the fluid exhaust lid 32 is held tightly against the can 30. Thus, the features of the armature 14 being pulled in a direction generally designated by arrow A1, and the fluid exhaust lid 32 being drawn or pulled in a direction opposite arrow A1, causes the pressure balanced solenoid control valve 10 to behave in a “clapping” motion such that in an activated state, the armature 14 and fluid exhaust lid 32 are generally drawn toward one another.

When the coil 60 is de-energized, an “off response” (see, e.g. FIG. 5) of the pressure balanced solenoid control valve 10 may occur. In this off state response, the inlet pressure P1 is seen in the magnetic air gap MG1 at the second end 90 of the armature 14 and biases the armature 14 away from the pole piece 54 and against an inner wall 92 of the nose portion 12 in a direction generally opposite that designated by arrow A1. As such, the inlet pressure P1 in the first magnetic air gap MG1 assists the conical coil armature spring 20 in maintaining the off state response of, for example, a valve lifter system, thereby ceasing the supply of the inlet pressure P1 to the control port CP and reducing the outlet pressure P2.

As generally represented in FIG. 5, it will be appreciated that the outlet pressure P2 is maintained at a minimum pressure value of, for example, approximately 10 psi, by way of fluid communicated from the supply port SP through the radial bleed orifice 44 of the nose portion 12. Additionally, the fluid exhaust regulation provided by the fluid exhaust lid 32 and leaf spring 34 may be enabled in the off state response as a result of relieving a force applied in the direction generally opposite the direction of arrow A1 on the exhaust lid 32, such that the fluid exhaust lid 32 is held in a loose, but biased engagement against the can 30 by the leaf spring 34.

Accordingly, as generally represented in FIG. 4, when the coil is energized, a level of outlet pressure P2 sufficient to operate a feature (e.g., a valve lifter activation/deactivation mechanism) is set to, for example 27 psi, which may occur at approximately 6 ms at an operating current of approximately 0.7 amperes. As generally represented in FIG. 5, when the coil is de-energized, a level of the outlet pressure P2, which is, for example, approximately equal to 12 psi, is sufficient for activating a feature (e.g., a valve train) and may occur, for example, at approximately 11 ms.

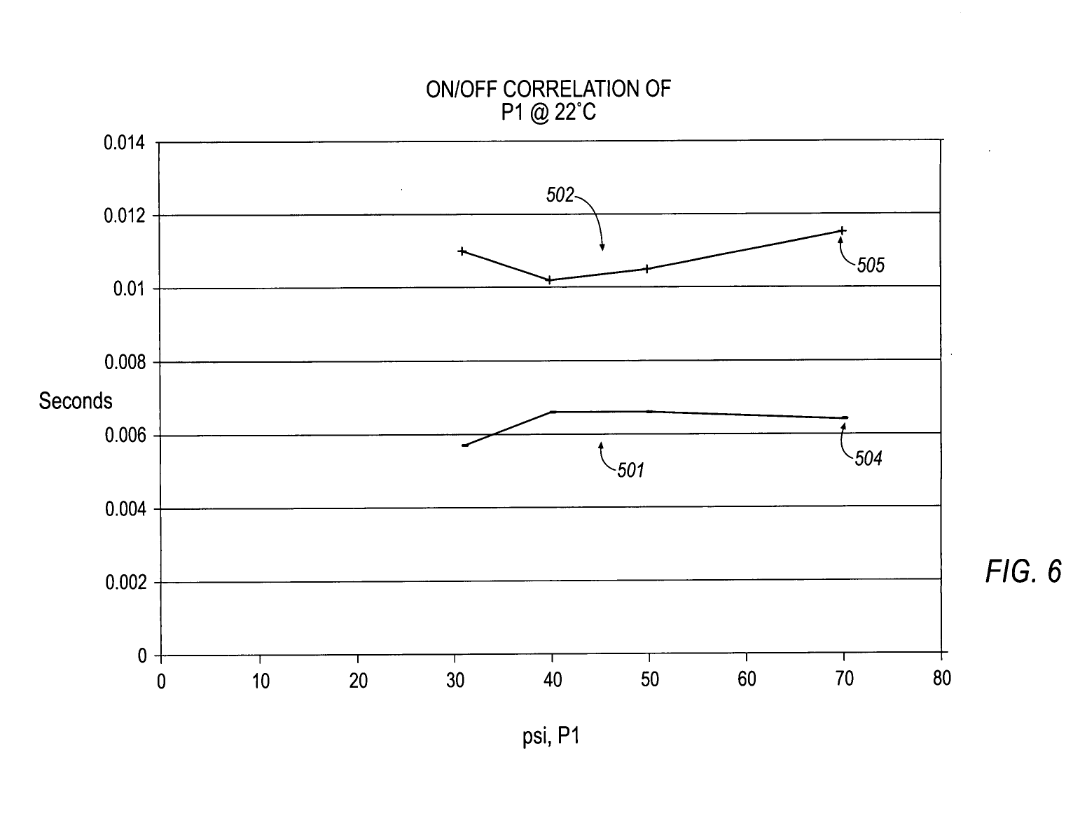

FIG. 6 illustrates a potential on/off response correlation chart for a sampling of a pressure balanced valve according to an embodiment of the invention when operated by a fluid inlet pressure P1 of approximately 30 psi, 40 psi, 50 psi, and 70 psi, all at 22° C. Each sample plot at 30 psi, 40 psi, 50 psi, and 70 psi generally represents the time when a sufficient outlet pressure P2 occurs for operating a feature (e.g., a valve lifter activation/deactivation system). As such, curves 501, 502 represents a sufficiency of the outlet pressure P2 for an “on response” and an “off response,” respectively, when the inlet pressure P1 is at about 30 psi, 40 psi, 50 psi, and 70 psi. A datum point 504 on curve 501 generally relates to the sufficiency of the outlet pressure P2 of the “on response,” such as generally illustrated in FIG. 4, of approximately 6 ms when the inlet pressure P1 is 70 psi. A datum point 505 on curve 502 generally relates to the sufficiency of the outlet pressure P2 of the “off response,” such as generally illustrated in FIG. 5, of approximately 11 ms when the inlet pressure P1 is 70 psi.

When comparing the operating responses of inlet pressures P1 of 30 psi, 40 psi, 50 psi, and 70 psi, it can be seen that the “on response,” regardless of inlet pressure P1 is generally the same, or flattens out, at approximately 6 ms; while the “off response,” regardless of inlet pressure P1, is generally the same, or flattens out, at approximately 10.5 ms. Accordingly, the design of the pressure balanced solenoid control valve 10 can generally provide a consistent on/off response time of the outlet pressure P2 regardless of inlet pressure P1.

In addition to potentially providing an improved, such as flattened, response performance (e.g., as generally shown in FIG. 6), a pressure balanced solenoid control valve according to an embodiment of the present invention may be less expensive when compared to conventional solenoid control valves due, at least in part, to the elimination of ball valves, check valves, a large, heavy armature and/or a spring (such as spring 106). Further, the elimination of a large, heavy armature and spring can reduce the amount of material needed and, as a result, less magnetic flux may be needed to operate the valve. Thus, in addition to improved performance, it will be appreciated that a pressure balanced solenoid control valve 10 may be significantly smaller and more efficient than conventional solenoid control valve, and, as such, may have greater applicability to other features/systems, particularly those requiring a solenoid valve having a smaller packaging size/dimensions.

The present invention has been particularly shown and described with reference to the foregoing embodiments, which are merely illustrative of the best mode or modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A pressure balanced solenoid control valve, comprising:
a member including a bore having a first end and a second end;
an armature extending at least partially into the bore through the first end; and
a pole piece extending at least partially into the bore through the second end,
wherein an inlet pressure is provided between the armature and pole piece to bias the armature away from the pole piece.

2. The pressure balanced control valve according to claim 1, wherein the inlet pressure is communicated through an orifice in the armature.

3. The pressure balanced solenoid control valve according to claim 1 further comprising an exhaust regulator positioned adjacent an end of the pole piece proximate the second end of the bore.

4. The pressure balanced solenoid control valve according to claim 3, wherein the exhaust regulator includes an exhaust lid, wherein the exhaust lid is positioned adjacent the end of the pole piece.

5. The pressure balanced solenoid control valve according to claim 1, wherein the control valve includes a coil formed around or about the member, and the pole piece and armature are attracted toward one another when the coil is excited.

6. The pressure balanced solenoid control valve according to claim 5, wherein the excitation of the coil at least in part permits an outlet fluid pressure to flow toward a control port.

7. The pressure balanced solenoid control valve according to claim 1, wherein the member comprises a bobbin.

8. The pressure balanced solenoid control valve according to claim 7 further comprising a spring positioned between an end plate of the bobbin and a disk portion of the armature.

9. The pressure balanced solenoid control valve according to claim 1, wherein the inlet pressure is communicated from a supply port.

10. The pressure balanced solenoid control valve according to claim 1, a magnetic air gap is formed between the armature and the pole piece when an inlet pressure is provided between the armature and the pole piece.

11. The pressure balanced solenoid control valve according to claim 1, wherein the inlet pressure includes a hydraulic fluid pressure.

12. The pressure balanced solenoid control valve according to claim 11, wherein the hydraulic fluid pressure includes engine oil under pressure.

13. A method for operating a solenoid control valve, comprising:
providing a member including a bore having a first end and a second end, an armature extending at least partially into the bore through the first end; and a pole piece extending at least partially into the bore through the second end;
providing an inlet pressure between the armature and the pole piece to bias the armature away from the pole piece.

14. The method according to claim 13, further comprising:
activating a coil associated with the member to attract the armature towards the pole piece.

15. The method according to claim 14, wherein the attraction of the armature toward the pole piece at least in part permits an outlet fluid pressure to flow toward a control port.

16. The method according to claim 13, further comprising:
exhausting the inlet pressure using an exhaust regulator positioned adjacent an end of the pole piece.

17. The method according to claim 13, wherein providing an inlet pressure includes providing hydraulic fluid pressure from a supply port through an orifice extending through the armature.

18. The method according to claim 13, wherein a spring is positioned between an end plate of a bobbin and a disk portion of the armature to assist the inlet pressure in biasing the armature in a direction away from the pole piece.
